(19) United States
(12) Patent Application Publication
(10) Pub. No.: US 2020/0401712 A1
(43) Pub. Date: Dec. 24, 2020

(54) COMMAND LINE INTERFACE REPLACEMENT FOR SECURITY PURPOSES

(71) Applicant: Gil KEINI, Nirit (IL)

(72) Inventor: David KEINI, Haifa (IL)

(21) Appl. No.: 17/009,418

(22) Filed: Sep. 1, 2020

Related U.S. Application Data
(63) Continuation of application No. PCT/IL2019/050225, filed on Feb. 28, 2019.
(60) Provisional application No. 62/637,137, filed on Mar. 1, 2018.

(51) Int. Cl. G06F 21/62; G06F 21/31

(52) U.S. Cl. CPC G06F 21/629; G06F 21/31

(57) ABSTRACT

A computer program product, a computerized apparatus and a method for strengthening the security of Command Line Interface (CLI) of an Operating System (OS), by limiting the allowed operations via the CLI. The method comprises: obtaining a user account having an access to the OS via a CLI configured to receive commands from the user and execute a predetermined functionality in the OS; creating an operation profile for the user account having a list of authorized commands in the CLI for the user account that excludes a command of the CLI or a parameter thereof; and deploying a CLI-Replacement Component (CRC) in the OS that is associated with the user account. The CRC is a CLI layer that is configured to limit executed commands in the OS based on the operation profile, whereby the CRC only sends commands adhering with the operation profile for execution by the OS.

### CROSS-REFERENCE TO RELATED APPLICATION

This application is a continuation of International Application No. PCT/IL2019/050225 which claims the benefit of U.S. Provisional Application No. 62/637,137 filed Mar. 1, 2018, entitled “ LIMITED COMMAND LINE INTERFACE FOR SECURITY PURPOSES”, each of which are hereby incorporated by reference in their entirety.

### TECHNICAL FIELD

The present disclosure relates to cyber security in general, and to the computer security of endpoint devices having an operating system with command line interfaces, in particular.

### BACKGROUND

Computer security is the protection of computer systems from the theft and damage to their hardware, software or information, as well as from disruption or misdirection of the services they provide.

Computer security includes controlling physical access to the hardware, as well as protecting against harm that may come via network access, data and code injection. Furthermore, due to malpractice by operators, whether intentional or accidental, computer security may be susceptible to being tricked into deviating from secure procedures through various methods.

The field of computer security is of growing importance due to the increasing reliance on computer systems and the Internet, wireless networks such as Bluetooth and Wi-Fi, the growth in the use of computerized devices, or the like.

### BRIEF SUMMARY

One exemplary embodiment of the disclosed subject matter is a method comprising: obtaining a user account having an access to an Operating System (OS), wherein the OS comprises a Command Line Interface (CLI) configured to receive commands from the user and execute a predetermined functionality in the OS. The method further comprises creating an operation profile for the user account. The operation profile may comprise a list of authorized commands in the CLI for the user account. The operation profile may exclude at least one command of the CLI or at least one parameter of a command of the CLI. The method further comprises deploying a CLI-Replacement Component (CRC) in the OS. The CRC is associated with the user account. The CRC may be a CLI layer that is configured to limit executed commands in the OS based on the operation profile, whereby the CRC only sends commands adhering with the operation profile for execution by the OS.

Optionally, the method comprises generating the CRC based on the predetermined functionality and the operation profile of the user account.

Optionally, said creating the operation profile may be performed based on assignments with which the user is tasked.

Optionally, limiting the executed commands by the CRC may indifferent to file permissions in a file system of the OS, whereby the CRC prevents execution of a command for which the user account has execution permissions in the file system.

Optionally, the method comprises obtaining a second user account having an access to the OS, wherein the second user account is associated with a second user of the OS. The method further comprises creating a second operation profile for the second user account, wherein the second operation profile comprises a second list of authorized commands in the CLI for the second user account. The second operation profile excludes at least one command of the CLI or at least one parameter of a command of the CLI. The method further comprises deploying a second CRC in the OS. The second CRC may be associated with the second user account. The second CRC may be a CLI layer that is configured to limit executed commands in the OS based on the second operation profile, whereby the CRC only sends commands adhering with the second operation profile for execution by the OS. The CRC and the second CRC may be different.

Optionally, said creating the operation profile comprises: displaying a list of commands of the OS to an administrator of the OS; and generating the list of authorized commands based on a selection of the administrator of enabled commands from the list of commands.

Optionally, said creating the operation profile further comprises: obtaining a permission template indicating a set of enabled commands in the OS; wherein said displaying comprises displaying the list of commands and indicating the set of enabled commands as initially enabled; whereby providing the administrator with an initial list of authorized commands.

Optionally, the CRC is configured to enable execution of a first command, wherein the first command is configured to be executed in the OS with a at least one parameter; wherein based on the operation profile, the CRC is configured to prevent executing the first command with at least one value of the at least parameter of the first command.

Optionally, the operation profile limits a number of commands allowed to be executed by the OS to less than 10% of a number of commands of the OS.

Optionally, said deploying the CRC in the OS comprises replacing the CLI of the OS with the CRC, wherein said replacing comprises deleting the CLI of the OS to prevent execution of the CLI.

Another exemplary embodiment of the disclosed subject matter is a computerized apparatus having a processor, the processor being adapted to perform the steps of: obtaining a user account having an access to an OS. The OS comprises a CLI configured to receive commands from the user and execute a predetermined functionality in the OS; creating an operation profile for the user account, wherein the operation profile comprises a list of authorized commands in the CLI for the user account, wherein the operation profile excludes at least one command of the CLI or at least one parameter of a command of the CLI; and deploying a CRC in the OS, wherein the CRC is associated with the user account, wherein the CRC is a CLI layer that is configured to limit executed commands in the OS based on the operation profile, whereby the CRC only sends commands adhering with the operation profile for execution by the OS.

Optionally, the processor is further adapted to perform the steps of: generating the CRC based on the predetermined functionality and the operation profile of the user account.

Optionally, said creating the operation profile is performed based on assignments with which the user is tasked.

Optionally, limiting the executed commands by the CRC is indifferent to file permissions in a file system of the OS, whereby the CRC prevents execution of a command for which the user account has execution permissions in the file system.

Optionally, the processor is further adapted to perform the steps of: obtaining a second user account having an access to the OS, wherein the second user account is associated with a second user of the OS; creating a second operation profile for the second user account, wherein the second operation profile comprises a second list of authorized commands in the CLI for the second user account, wherein the second operation profile excludes at least one command of the CLI or at least one parameter of a command of the CLI; and deploying a second CRC in the OS, wherein the second CRC is associated with the second user account, wherein the second CRC is a CLI layer that is configured to limit executed commands in the OS based on the second operation profile, whereby the CRC only sends commands adhering with the second operation profile for execution by the OS; wherein the CRC and the second CRC are different.

Optionally, said creating the operation profile comprises: displaying a list of commands of the OS to an administrator of the OS; and generating the list of authorized commands based on a selection of the administrator of enabled commands from the list of commands.

Optionally, said creating the operation profile further comprises: obtaining a permission template indicating a set of enabled commands in the OS; wherein said displaying comprises displaying the list of commands and indicating the set of enabled commands as initially enabled; whereby providing the administrator with an initial list of authorized commands.

Optionally, the CRC is configured to enable execution of a first command, wherein the first command is configured to be executed in the OS with a at least one parameter; wherein based on the operation profile, the CRC is configured to prevent executing the first command with at least one value of the at least parameter of the first command.

Optionally, said deploying the CRC in the OS comprises replacing the CLI of the OS with the CRC, wherein said replacing comprises deleting the CLI of the OS to prevent execution of the CLI.

Yet another exemplary embodiment of the disclosed subject matter is a computer program product comprising a non-transitory computer readable storage medium retaining program instructions, which program instructions when read by a processor, cause the processor to perform a method comprising: obtaining a user account having an access to an OS. The OS comprises a CLI configured to receive commands from the user and execute a predetermined functionality in the OS; creating an operation profile for the user account, wherein the operation profile comprises a list of authorized commands in the CLI for the user account, wherein the operation profile excludes at least one command of the CLI or at least one parameter of a command of the CLI; and deploying a CRC in the OS, wherein the CRC is associated with the user account, wherein the CRC is a CLI layer that is configured to limit executed commands in the OS based on the operation profile, whereby the CRC only sends commands adhering with the operation profile for execution by the OS.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter; and

FIG. 2 shows a block diagram of an apparatus, in accordance with some exemplary embodiments of the disclosed subject matter.

### DETAILED DESCRIPTION

One technical problem dealt with by the disclosed subject matter is to secure Operating Systems (OS) from cyber or security attacks. Computerized or automated systems and devices may operate using a CLI. The CLI may be used by valid or malicious programs (as a Shell to access the OS, providing commands thereto, or the like. The CLI may be used to receive action requests from the user to be processed by the OS. These action requests may be inherent commands of the OS, request to execute a script file, a request to execute a sequence of CLI commands or actions used for task automation, a request to execute a binary executable, a request to execute an application, or the like. In some exemplary embodiments, the command line may receive command written at a shell prompt, commands written directly to the shell, or the like. The same OS may operate through a number of different CLIs.

In some exemplary embodiments, a user working on a computer (or a computerized system) may try to perform an unauthorized action by mistake or with a malicious intent. In some scenarios, specific malware may attempt to inject commands into a CLI, as if they were typed by a human, in order to evade detection and/or bypass security mechanisms limiting applications. Open or accessible capability may be a dangerous vulnerability that may be used by hackers, malware or the like, to attack computerized systems.

Solutions or technologies, such as firewall, antiviruses, or the like may not be helpful in many cases. As an example, firewall that is used to control incoming communication connections, may set no limits on the user's local actions, or for a malware executing action on the local computer. As another example, antivirus may usually be based on a “signature”/“fingerprint” database of known malware. Such antiviruses may not be configured to look into the user's own action. Such antiviruses may not place any limits on the user's action. As yet another example, User Access Lists (ACL), such as an access control list, with respect to a computer file system, may be a list of permissions attached to an object. An ACL may specify which users or system processes are granted access to objects, as well as what operations are allowed on given objects. This mechanism may be good for limiting access to certain local files, but may not be able to limit the actions of the user, malware running under the same permissions of the user, or the like. As yet another example, heuristic monitoring which may be a mechanism attempting to discern “right” or “correct” behavior of applications, may be configured to monitor the actions but not to limit the user. Anomalies may be detected in retrospect, and suitable action may be performed in response to such anomalies. As yet another example, file & application whitelisting may be used when the platform is stable over a long period of time (e.g., when the system operates for a while without introducing changes). Using this method may allow execution of certain applications but may not limit their access and capabilities. There may exist a class of attacks that injects code and initiates malicious actions under the “cover” of a pre-approved application. This method may not be able to monitor nor limit the user's local actions.

In some exemplary embodiments, OSs may be configured by default to provide a full set of commands to all of the users. Every user may be able to access all commands, and the full set of features, arguments, parameters, or the like of the commands. No fine-grain limitations may be provided. At best, the operating system may provide a limited access to applications or files, but not for system utilities which can be used to great damage, directly or indirectly (such as turning off safety/security mechanisms, or the like).

Some solutions may deal with many other aspects of computer platform security. However, such solution may try to deal with security threats by monitoring running processes, looking for malicious files (based on signatures or behavior), limiting access rights by location of target files, or the like. While such solutions are effective against certain types of attacks, they may not be as effective for protection of stand-alone devices, malicious users (including insider threat), accidental damage by non-malicious users (e.g., mistaken users or users that are taken advantage of without their knowledge), or the like. As one example, no existing solution is configured to limit the user's action in CLI, such as limiting the user's ability to provide a command to the CLI to format the storage device or turn off security features.

One technical solution is to strengthen the security of CLI of the OS, by limiting the allowed operations via the CLI. Users may rarely access and utilize the full set of the OS supported actions. It may be very common for a user to access a limited subset of the OS commands and even then, a limited variation of input parameters or arguments may be utilized. The user may also access a limited subset of applicable scripts, applications, or the like. The access of the user may be limited to the relevant capabilities only.

In some exemplary embodiments, the strengthening CLI of the OS may be performed by replacing the CLI with a limited CLI, by adding additional interface layer to the CLI, or the like. In some exemplary embodiments, the CLI limiting may be performed by limiting executed commands in the OS for a user, based on an operation file associated therewith. The operation profile may define selective actions limitation, for each user profile. In some exemplary embodiments, the user's actions may be limited to the minimal subset of capabilities and lowest level of user rights, that may still allow the user to perform her intended assignment.

In some exemplary embodiments, an operation profile may be created for each user account having an access to OS and sending commands via the CLI to execute a predetermined functionality in the OS. The operation profile may comprise a list of authorized commands in the CLI for the user account. In some exemplary embodiments, the list of authorized commands may be generated by active filtration of allowed actions based on specific definition of specific usage-profile of the user. It may be noted that security of the operating system may be managed based on the Principle Of Least Privilege (POLP). POLP may be the practice of limiting access of the user to the minimal level that will allow normal functioning. Applied to users (employees and/or applications running on the computer), the principle of least privilege translates into giving the user, the lowest level of rights/authorization required to perform their designated tasks.

In some exemplary embodiments, the user's operating profile may be limited based on POLP by blocking a portion of the OS command capabilities. As an example, a normal Personal Computer (PC) user may be able to operate with access to less than about 5%-10% of system capabilities, commands, system utilities, or the like. The principle of least privilege (POLP) may be the practice of limiting access to the minimal level that will still allow normal functioning of the user. POLP may require that in a particular abstraction layer of a computing environment, every module (such as a process, a user, or a program, or the like) may be able to access only the information and resources that are necessary for its legitimate purpose. The principle means giving a user account only those privileges that are essential to perform its intended function. For example, a user account for the sole purpose of creating backups may not be required install software: hence, it may have access only to run backup and backup-related applications. Any other privileges, such as installing new software, deleting existing data, or the like, may be blocked. Applied to employees, the POLP translates to giving people the lowest level of user rights that they can have and still do their jobs.

In some exemplary embodiments, Manual (MAN) pages of the OS, native help file on CLI commands, software documentations, or the like may be used in order to define the operating profile of the user. A set-up module may be configured to automatically learn commands, parameters, types, values, enumerated types, or the like that are associated with the user and the OS.

In some exemplary embodiments, the OS to be protected may be mapped to determine a list of all the CLI capabilities. The list may be presented to the system administrator. The system administrator may mark only the necessary commands and command-arguments needed for the user to perform the designated task. As an example, the administrator may limit a specific command to external flash-storage device, but not the main local or network storage device. Additionally or alternatively, the limited commands may be defined based on a role of the user, such as Office Administrator, Software Developer, IT-Administrator, or the like. In some exemplary embodiments, a user may be allowed to use a command but limited with which options or parameters to use it, such as blocking the—KILL option of the kill command in LINUX™, limiting the user's ability to perform “1s” command with respect to certain directories (e.g., based on a regular expression of allowed directories, based on allowed filesystems, or the like), It may be possible to use pre-defined (“template”) profiles and add or remove capabilities therefrom.

In some exemplary embodiments, a CRC may be generated and deployed a in the OS. The CRC may be associated with the user account, and may be generated based on the operation profile thereof. The CRC may be a CLI layer that is configured to limit executed commands in the OS based on the operation profile. The CRC may be configured to send only commands adhering with the operation profile for execution by the OS.

In some exemplary embodiments, the CRC may have an input validating ability with access to a repository of users' profile and minimal required access-rights. All input to the CLI may be processed and monitored by the CRC. Only commands and specific parameters, arguments, inputs to the commands, or the like; which strictly adhere to the operation profile, may be allowed through to the OS.

In some exemplary embodiments, the CRC may be configured to provide for a smart CLI filtering-gating component. The CRC may be retro-fitted to existing systems, such as an add-on internal software component that replaces the native shell/CLI provided by the OS. In some exemplary embodiments, the CRC may be deployed on each computer, computerized machine, or the like. The filtering-gating component, may be configured to intercept the input to CLI (such as via keyboard, by command injection, or the like). The CRC may be configured to enforce the correct and safe usage, by analyzing and comparing against the pre-defined whitelist (content, structure, rules, or the like.) The CRC may be configured to deterministically detect unsafe usage thereby allowing logging, reporting, filtering, blocking or the like.

Additionally or alternatively, the CRC may be configured to perform input validation against one or more groups or subsets of commands, arguments, variants thereof, or the like. The variants may be generated using a combination of switches and options.

In some exemplary embodiments, the CRC may be configured to perform different actions for different types of commands. Authorized commands or arguments may be passed to the OS. Dangerous commands determined by the CRC may be blocked and reported, such as to IT-department manager. Additionally or alternatively, dangerous commands may be passed based on external event or intervention, such as an explicit approval by the IT-department manager. This may provide a tighter control over commands with potential for significant damage. The approval may be time-limited, limited to a single usage, or the like. High-alerted commands may cause a different level of alert to be sent due to specific usage patterns which may be associated with malpractice, malicious activity, or the like.

In some exemplary embodiments, the method may comprise utilizing an off-line set-up module and utilizing a runtime protective module. The set-up module may be utilized for configuring the access rights and producing the specific protected shell for each user. The set-up module may be executed in an off-line manner. The set-up module may be utilized to configure a specific operating profile for each user. The runtime protective module may provide the CRC for the OS. The runtime protective module may replace the existing CLI of the OS.

Additionally or alternatively, the runtime protective module may be configured to work or integrate with Lightweight Directory Access Protocol LDAP to sync users, names, permissions, or the like. The runtime protective module may be configured to limit the commands and applications allowed to run on the computer.

In some exemplary embodiments, when a runtime module detects an attempt to perform an unauthorized action, the runtime module may be configured to send an alert with supporting information to the central monitoring station. As an example, the alert may be a string, command, text, or the like, entered into the CLI. Real-time alerts may be provided on attempted hacking, malware, or the like. Additionally or alternatively, the supporting information may be considered as an Indicator Of Compromise (IOC) and may be compared against known IOCs and used to identify the specific attack.

In some exemplary embodiments, optional monitoring and reporting may be performed. The reporting may be provided back to the enterprise's centralized command and control station, in order to provide a real-time map of the computers and network health and policy adherence.

In some exemplary embodiments, the solution of the disclosed subject matter, may be effective for any system that runs an OS with CLI. In particular, the disclosed solution may be applicable in the enterprise market. The disclosed solution may aim to protect different types of operating systems, such as Windows™, Linux™, MacOS™, or the like. The disclosed solution may be also applicable to different network equipment, desktops, servers, Secure Shell (SSH)-based accesses, or the like, as such services may issue commands to the system via the CLI interface.

One technical effect of utilizing the disclosed subject matter is instantly gaining a robust layer of security, against attacks, misuse, human-errors based on misuse or abuse of the CLI capabilities, or the like. Only commands and specific parameters, arguments, inputs to the commands, or the like; which strictly adhere to the operation profile, may be allowed through to the OS. This way there may be no need for attack signatures, or heuristic behavior monitoring. The defensive method and mechanism may easily be fitted to any operating system, including currently deployed systems and without the need for upgrade or changing the system itself.

Another technical effect of utilizing the disclosed subject matter is enhancing the robustness and resiliency of endpoint devices having an operating system with command line interfaces, against misuse, erroneous usage which may result in system down-time, business damages due to system mal-function and inaccessible service, or the like.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

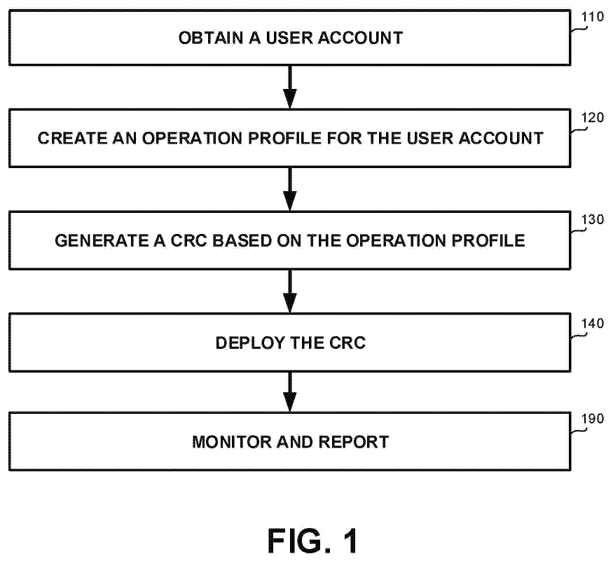

Referring now to FIG. 1 showing a flowchart diagram of a method, in accordance with some exemplary embodiments of the disclosed subject matter.

On Step 110, a user account may be obtained. In some exemplary embodiments, the user account may have an access to an OS that comprises a CLI. The CLI may be configured to receive commands from the user and execute a predetermined functionality in the OS. A user may be a person, an application running in a specific context, or the like.

On Step 120, an operation profile may be created for the user account. The operation profile may comprise a list of authorized commands in the CLI for the user account. The operation profile may exclude at least one command of the CLI or at least one parameter of a command of the CLI. In some exemplary embodiments, the operation profile may be determined based on the user's excepted activity, historic activity, role in the organization, or the like. Additionally or alternatively, the operation profile may be created based on assignments with which the user is tasked. The operation profile may be configured to limit the access of the user to the minimum command allowing the user to perform the assignments.

In some exemplary embodiments, the list of authorized commands may be generated based on a selection of an administrator of the OS of enabled commands from a list of commands displayed thereto. The list may be configured to indicate allowed CLI actions, define allowed templates of usage of CLI actions if only a portion of the capabilities of a CLI action is allowed, define which arguments of CLI actions are allowed, or the like. The list of authorized commands may be generated based on an initial permission template indicating a set of enabled commands in the OS. Commands authorized by the administrator may be added to the initial permission template to generate the list of authorized commands. Additionally or alternatively, the list of commands displayed to the administrator may indicate the set of enabled commands as initially enabled, to provide the administrator with an initial list of authorized commands.

In some exemplary embodiments, several pre-defined operation profiles, default policies, or the like, may exist. Such operation profiles may be modified and connected to existing LDAP profiles when needed.

On Step 130, a CRC may be generated based on the predetermined functionality and the operation profile of the user account. In some exemplary embodiments, the CRC may be associated with the user account. The CRC is may be CLI layer that is configured to limit executed commands in the OS based on the operation profile. Once the expected subset of CLI actions has been defined by the operation profile, the definition may be used to automatically generate enforcement rules as a software source code, a configuration file to a “generic” shell replacement, or the like. The CRC may be a dedicated CLI replacement component having a smart user-input (CLI) filtering capability.

It may be appreciated that different operation profiles may be created for different user accounts, and accordingly different CRCs may be generated based thereupon. In some exemplary embodiments, the operation profile may limit a number of commands allowed to be executed by the OS to less than 10% of a number of commands of the OS.

On Step 140, the CRC may be deployed in the OS. In some exemplary embodiments, the CRC may be configured to send for execution by the OS only commands adhering with the operation profile.

In some exemplary embodiments, the CRC may be configured to prevent at least one command of the CLI from being executed by the OS. Additionally or alternatively, the CRC may be configured to enable execution of a command that is configured to be executed in the OS with parameters, while preventing execution of the command with at least one value of the parameter.

In some exemplary embodiments, the CRC may be retro-fitted to existing OS. The deployment may be performed as an add-on internal software component that replaces the CLI provided by the OS. In some exemplary embodiments, the CLI of the OS may be deleted and replaced by the CRC to prevent execution of the CLI. Additionally or alternatively, the CRC may be deployed in addition to the CLI.

It may be appreciated that limiting the executed commands by the CRC may be indifferent to file permissions in a file system of the OS. The CRC may be configured to prevent execution of a command for which the user account has execution permissions in the file system.

On Step 190, the user's activity may be monitored and reported to verify the expected user profile or modify thereof, such as in case the user's activity changes over time. As an example, if the user assignment is updated, and a new CLI command is required to perform the assignment, the administrator may update the user profile and re-generate the CRC based thereon. Additionally or alternatively, actions executed in the OS may be monitored during usage of the CRC to find anomalies. The anomalies may be blocked, reported, used to update the CRC, or the like. In some exemplary embodiments, in view of the monitored actions, the operation profile may be updated and Steps 110-140 may be re-performed, thereby evolving the CRC over time in view of the user's expected usage.

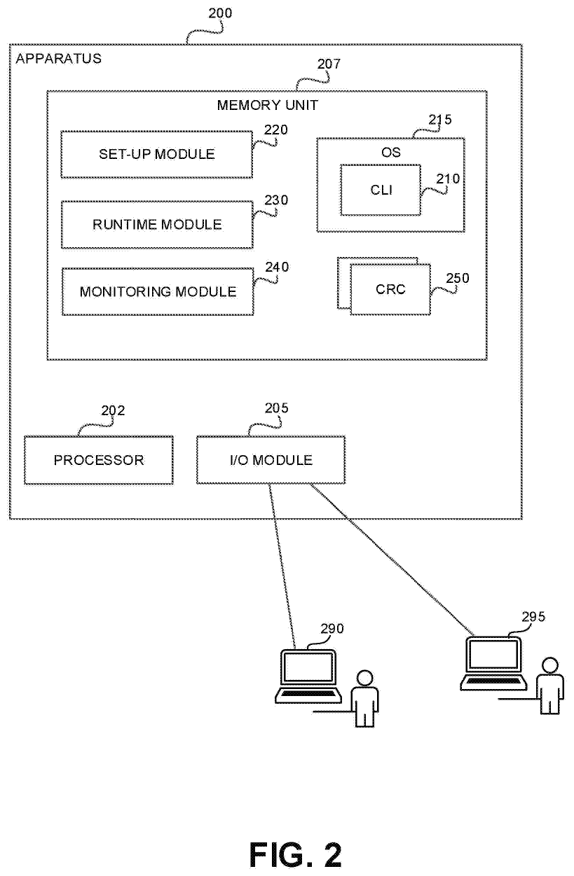

Referring now to FIG. 2 showing a block diagram of an apparatus, in accordance with some exemplary embodiments of the disclosed subject matter.

In some exemplary embodiments, Apparatus 200 may comprise one or more Processor(s) 202. Processor 202 may be a Central Processing Unit (CPU), a microprocessor, an electronic circuit, an Integrated Circuit (IC) or the like. Processor 202 may be utilized to perform computations required by Apparatus 200 or any of its subcomponents. In some exemplary embodiments, Apparatus 200 may be configured to protect varied systems or devices against misuse, such as but not limited to: hacking, malicious users, command injections by malware, or the like, that may perform the misuse via CLI thereof.

In some exemplary embodiments of the disclosed subject matter, Apparatus 200 may comprise an Input/Output (I/O) module 205. I/O Module 205 may be utilized to provide an output to and receive input from a user, such as, for example from User Account 290, User Account 295, or the like. I/O Module 205 may be utilized to provide an input to OS 215 or to CLI 215, such as via a keyboard, a command injection, or the like.

In some exemplary embodiments, Apparatus 200 may comprise a Memory 207. Memory 207 may be a hard disk drive, a Flash disk, a Random Access Memory (RAM), a memory chip, or the like. In some exemplary embodiments, Memory 207 may retain program code operative to cause Processor 202 to perform acts associated with any of the subcomponents of Apparatus 200.

In some exemplary embodiments, different user accounts such as User Account 290 and User Account 295 may have an access to an OS 215 of Apparatus 200. OS 215 may comprise a CLI 210 configured to receive commands from users and execute a predetermined functionality in OS 215.

In some exemplary embodiments, Apparatus 200 may comprise a Set-Up Module 220. Set-Up Module 220 may be configured to define an operation profile for each user account of Apparatus 200. The operation profile may comprise a list of authorized commands in CLI 210 for the user account. The operation profile may be configured to exclude at least one command of CLI 210, at least one parameter of a command of CLI 210, or the like. Set-Up Module 220 may be configured to define different operation profiles for different user accounts.

In some exemplary embodiments, Set-Up Module 220 may be configured to generate, for each user account (or operation profile) a CRC 250, based on the predetermined functionality and the operation profile of the user account. Different CRCs 250 may be generated for different User Accounts 290, 295. Set-Up Module 220 may be configured to construct a set of rules operation profile for each device running OS 215. The set of rules may define the allowed commands, parameters or arguments used by the allowed commands, applications, scripts, or the like. CRC 250 may be a CLI layer that is configured to limit executed commands in OS 215 based on the operation profile. CRC 250 may be configured to send for execution by OS 215, only commands adhering with the operation profile.

In some exemplary embodiments, Apparatus 200 may comprise a Runtime Module 230. Runtime Module 230 may be configured to enforce list of authorized commands in CLI 210 of each user account, based on the operation profile thereof. Runtime Module 230 may be configured to prevent the user from performing unauthorized CLI actions. Runtime Module 230 may be configured to deploy the different CRCs 250 in OS 215 for different user accounts. In some exemplary embodiments, Runtime Module 230 may be configured to deploy CRC 250 instead of CLI 215. Additionally or alternatively, Runtime Module 230 may be configured to deploy CRC 250 as an additional layer to CLI 215. Input to CLI 210 may be detected by the relevant CRC 250. Commands and parameters of the input may be validated against preset rules describing operation-profile. CRC 250 may be configured to send only commands and actions which adhere to the predefined specifications described by the set of rules may be sent to the operating-system's original CLI for execution.

In some cases, if a new CLI action is desired to be indicated as allowable, an administrator may update the user profile and re-invoke Set-Up Module 220 to enable the new CLI action.

In some exemplary embodiments, Apparatus 200 may comprise a Monitoring Module 240. Monitoring Module 240 may be configured to monitor the user's activity, and report on such activity. In some cases, Monitoring Module 240 may be used to monitor to user's activity to verify the expected user profile or modify thereof, such as in case the user's activity changes over time.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining a user account having an access to an Operating System (OS), wherein the OS comprises a Command Line Interface (CLI) configured to receive commands from the user and execute a predetermined functionality in the OS;
creating an operation profile for the user account, wherein the operation profile comprises a list of authorized commands in the CLI for the user account, wherein the operation profile excludes at least one command of the CLI or at least one parameter of a command of the CLI; and
deploying a CLI-Replacement Component (CRC) in the OS, wherein the CRC is associated with the user account, wherein the CRC is a CLI layer that is configured to limit executed commands in the OS based on the operation profile, whereby the CRC only sends commands adhering with the operation profile for execution by the OS.

2. The method of claim 1, further comprises:
generating the CRC based on the predetermined functionality and the operation profile of the user account.

3. The method of claim 1, wherein said creating the operation profile is performed based on assignments with which the user is tasked.

4. The method of claim 1, wherein limiting the executed commands by the CRC is indifferent to file permissions in a file system of the OS, whereby the CRC prevents execution of a command for which the user account has execution permissions in the file system.

5. The method of claim 1, further comprising:
obtaining a second user account having an access to the OS, wherein the second user account is associated with a second user of the OS;
creating a second operation profile for the second user account, wherein the second operation profile comprises a second list of authorized commands in the CLI for the second user account, wherein the second operation profile excludes at least one command of the CLI or at least one parameter of a command of the CLI; and
deploying a second CLI-Replacement Component (CRC) in the OS, wherein the second CRC is associated with the second user account, wherein the second CRC is a CLI layer that is configured to limit executed commands in the OS based on the second operation profile, whereby the CRC only sends commands adhering with the second operation profile for execution by the OS;
wherein the CRC and the second CRC are different.

6. The method of claim 1, wherein said creating the operation profile comprises:
displaying a list of commands of the OS to an administrator of the OS; and
generating the list of authorized commands based on a selection of the administrator of enabled commands from the list of commands.

7. The method of claim 6, wherein said creating the operation profile further comprises:
obtaining a permission template indicating a set of enabled commands in the OS;
wherein said displaying comprises displaying the list of commands and indicating the set of enabled commands as initially enabled;
whereby providing the administrator with an initial list of authorized commands.

8. The method of claim 1, wherein the CRC is configured to enable execution of a first command, wherein the first command is configured to be executed in the OS with a at least one parameter; wherein based on the operation profile, the CRC is configured to prevent executing the first command with at least one value of the at least parameter of the first command.

9. The method of claim 1, wherein the operation profile limits a number of commands allowed to be executed by the OS to less than 10% of a number of commands of the OS.

10. The method of claim 1, wherein said deploying the CRC in the OS comprises replacing the CLI of the OS with the CRC, wherein said replacing comprises deleting the CLI of the OS to prevent execution of the CLI.

11. A computerized apparatus having a processor, the processor being adapted to perform the steps of:
obtaining a user account having an access to an Operating System (OS), wherein the OS comprises a Command Line Interface (CLI) configured to receive commands from the user and execute a predetermined functionality in the OS;
creating an operation profile for the user account, wherein the operation profile comprises a list of authorized commands in the CLI for the user account, wherein the operation profile excludes at least one command of the CLI or at least one parameter of a command of the CLI; and
deploying a CLI-Replacement Component (CRC) in the OS, wherein the CRC is associated with the user account, wherein the CRC is a CLI layer that is configured to limit executed commands in the OS based on the operation profile, whereby the CRC only sends commands adhering with the operation profile for execution by the OS.

12. The computerized apparatus of claim 11, wherein the processor is further adapted to perform the steps of:
generating the CRC based on the predetermined functionality and the operation profile of the user account.

13. The computerized apparatus of claim 11, wherein said creating the operation profile is performed based on assignments with which the user is tasked.

14. The computerized apparatus of claim 11, wherein limiting the executed commands by the CRC is indifferent to file permissions in a file system of the OS, whereby the CRC prevents execution of a command for which the user account has execution permissions in the file system.

15. The computerized apparatus of claim 11, wherein the processor is further adapted to perform the steps of:
obtaining a second user account having an access to the OS, wherein the second user account is associated with a second user of the OS;
creating a second operation profile for the second user account, wherein the second operation profile comprises a second list of authorized commands in the CLI for the second user account, wherein the second operation profile excludes at least one command of the CLI or at least one parameter of a command of the CLI; and
deploying a second CLI-Replacement Component (CRC) in the OS, wherein the second CRC is associated with the second user account, wherein the second CRC is a CLI layer that is configured to limit executed commands in the OS based on the second operation profile, whereby the CRC only sends commands adhering with the second operation profile for execution by the OS;
wherein the CRC and the second CRC are different.

16. The computerized apparatus of claim 11, wherein said creating the operation profile comprises:
displaying a list of commands of the OS to an administrator of the OS; and
generating the list of authorized commands based on a selection of the administrator of enabled commands from the list of commands.

17. The computerized apparatus of claim 16, wherein said creating the operation profile further comprises:
obtaining a permission template indicating a set of enabled commands in the OS;
wherein said displaying comprises displaying the list of commands and indicating the set of enabled commands as initially enabled;
whereby providing the administrator with an initial list of authorized commands.

18. The computerized apparatus of claim 11, wherein the CRC is configured to enable execution of a first command, wherein the first command is configured to be executed in the OS with a at least one parameter; wherein based on the operation profile, the CRC is configured to prevent executing the first command with at least one value of the at least parameter of the first command.

19. The computerized apparatus of claim 11, wherein said deploying the CRC in the OS comprises replacing the CLI of the OS with the CRC, wherein said replacing comprises deleting the CLI of the OS to prevent execution of the CLI.

20. A computer program product comprising a non-transitory computer readable storage medium retaining program instructions, which program instructions when read by a processor, cause the processor to perform a method comprising:
obtaining a user account having an access to an Operating System (OS), wherein the OS comprises a Command Line Interface (CLI) configured to receive commands from the user and execute a predetermined functionality in the OS;
creating an operation profile for the user account, wherein the operation profile comprises a list of authorized commands in the CLI for the user account, wherein the operation profile excludes at least one command of the CLI or at least one parameter of a command of the CLI; and
deploying a CLI-Replacement Component (CRC) in the OS, wherein the CRC is associated with the user account, wherein the CRC is a CLI layer that is configured to limit executed commands in the OS based on the operation profile, whereby the CRC only sends commands adhering with the operation profile for execution by the OS.
